(19) United States
(12) Patent Application Publication
(10) Pub. No.: US 2023/0153886 A1
(43) Pub. Date: May 18, 2023

(54) INFORMATION PROCESSING DEVICE, CONTROL METHOD, AND STORAGE MEDIUM

(71) Applicant: NEC Corporation, Minato-ku, Tokyo (JP)

(72) Inventor: Kan ARAI, Tokyo (JP)

(73) Assignee: NEC Corporation, Minato-ku, Tokyo (JP)

(21) Appl. No.: 17/769,127

(22) PCT Filed: Oct. 31, 2019
(86) PCT No.: PCT/JP2019/042824

§ 371 Date: Apr. 14, 2022

(51) Int. Cl. G06Q 30/0601; G06Q 20/38

(52) U.S. Cl. CPC G06Q 30/0631; G06Q 20/389

(57) ABSTRACT

An information processing device 1C mainly includes an acquisition unit 30C and a determination unit 32C. The acquisition unit 30C acquires at least one of purchase record information indicative of a purchase record or the individual attribute information relating to an attribute of a customer who is a subject of mobile sales of a commodity, and presence information relating to a presence of the customer, the purchase record including a date and time of a purchase by the customer. The determination unit 32C determines, based on at least one of the purchase record information or the individual attribute information and the presence information, a timing of moving sales of a recommended commodity to be recommended to the customer.

### TECHNICAL FIELD

The present invention relates to a technical field of an information processing device, a control method, and a storage medium for performing processing related to commodity sales.

### BACKGROUND ART

An approach for deciding a commodity to be recommended to customers based on information such as attributes and purchase results for each customer has been proposed. For example, Patent Literature 1 discloses an approach for listing sales target commodities for individual customers based on customer information such as a customer identifier, a customer name, a customer address, a customer age, and a customer family configuration. Further, Patent Literature 2 discloses an autonomous mobile robot which autonomously moves toward a customer who visits the building and which proposes commodity information to the customer.

### CITATION LIST

### Patent Literature

Patent Literature 1: JP 2001-325523A
Patent Literature 1: JP 2019-049785A

### SUMMARY

### Problem to be Solved

Even when a commodity which the customer wants is predicted, the customer ends up not purchasing the commodity if the commodity is not provided at such a timing that the customer wants the commodity. This could lead to a loss of sales opportunities.

In view of the above-described issue, it is therefore an example object of the present disclosure to provide an information processing device, a control method and a storage medium capable of suitably prompting a customer to purchase commodities.

### Means for Solving the Problem

In one mode of the information processing device, there is provided an information processing device including: an acquisition unit configured to acquire at least one of purchase record information indicative of a purchase record or the individual attribute information relating to an attribute of a customer who is a subject of mobile sales of a commodity and presence information relating to a presence of the customer, the purchase record including a date and time of a purchase by the customer; and a determination unit configured to determine, based on at least one of the purchase record information or the individual attribute information and the presence information, a timing of moving sales of a recommended commodity to be recommended to the customer.

In one mode of the control method, there is provided a control method executed by an information processing device, the control method including: acquiring at least one of purchase record information indicative of a purchase record or the individual attribute information relating to an attribute of a customer who is a subject of mobile sales of a commodity and presence information relating to a presence of the customer, the purchase record including a date and time of a purchase by the customer; and determining, based on at least one of the purchase record information or the individual attribute information and the presence information, a timing of moving sales of a recommended commodity to be recommended to the customer.

In one mode of the storage medium, there is provided a storage medium storing a program executed by a computer, the program causing the computer to function as: an acquisition unit configured to acquire at least one of purchase record information indicative of a purchase record or the individual attribute information relating to an attribute of a customer who is a subject of mobile sales of a commodity and presence information relating to a presence of the customer, the purchase record including a date and time of a purchase by the customer; and a determination unit configured to determine, based on at least one of the purchase record information or the individual attribute information and the presence information, a timing of moving sales of a recommended commodity to be recommended to the customer.

### Effect

An example advantage according to the present invention is to suitably determine the timing of providing by mobile sales a recommended commodity, which is recommended to a customer, in accordance with the customer.

### BRIEF DESCRIPTION OF THE DRAWINGS

FIG. 1 illustrates a configuration of a commodity sales promotion system.

FIG. 2A illustrates a block configuration of an information processing device.

FIG. 2B illustrates a block configuration of a self-propelled robot.

FIG. 3 is an example of the data structure of an individual attribute DB (Database).

FIG. 4 is an example of the data structure of a purchase record DB.

FIG. 5 is an example of the data structure of a purchase prediction DB.

FIG. 6 is an example of the data structure of a recommendation method DB.

FIG. 7 is an example of the data structure of a trial history DB.

FIG. 8 is an example of a functional block of the processor of the information processing device.

FIG. 9 is an example of a flowchart showing a processing procedure executed by the information processing device according to a first example embodiment.

FIG. 10 is an example of a flowchart showing a processing procedure executed by the self-propelled robot according to the first example embodiment.

FIG. 11 illustrates a schematic configuration of a commodity sales promotion system according to a modification.

FIG. 12 illustrates a functional block of the processor of the self-propelled robot according to the modification.

FIG. 13 illustrates a schematic configuration of the commodity sales promotion system according to another modification.

FIG. 14 illustrates a schematic configuration of the information processing device according to a second example embodiment.

### EXAMPLE EMBODIMENTS

Hereinafter, an example embodiment of an information processing device, a control method, and a storage medium will be described with reference to the drawings.

### First Example Embodiment

(1) System Configuration

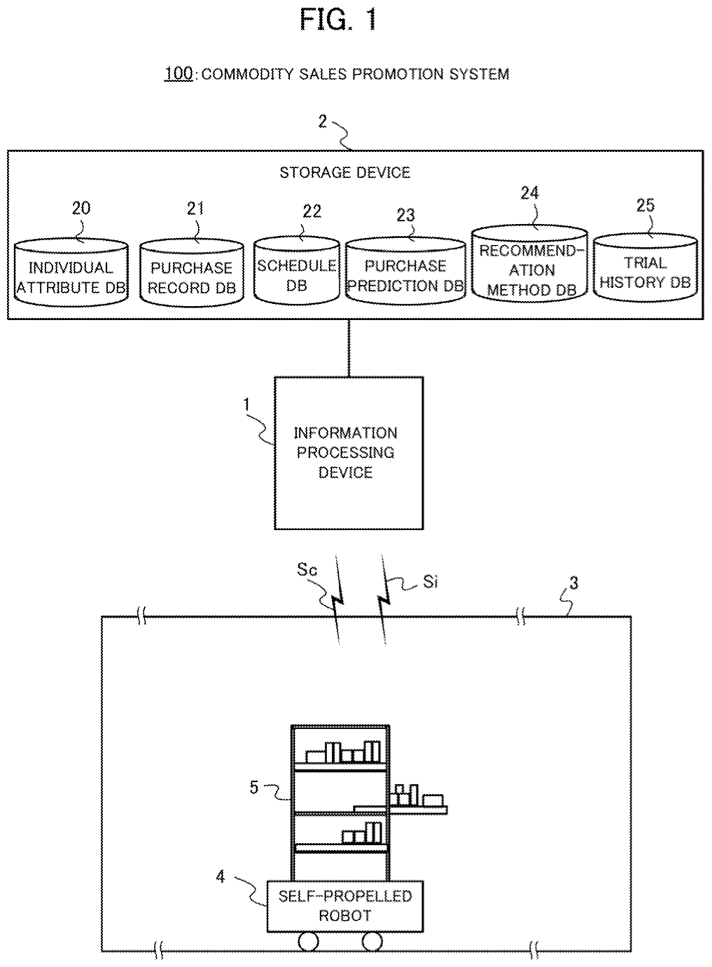

FIG. 1 illustrates a configuration of a commodity sales promotion system 100 according to a first example embodiment. The commodity sales promotion system 100 mainly includes an information processing device 1, a storage device 2, and a self-propelled robot 4 for performing mobile sales of commodities by autonomously moving in a predetermined sales target space 3. For example, the sales target space 3 is an office and the commodity sales promotion system 100 is an in-house sales system for employees having seats (or spaces) in the office. In another example, the sales target space 3 is a building used by a plurality of enterprises and the commodity sales promotion system 100 is a sales system for employees having seats in the sales target space 3. Hereafter, a subject of the mobile sales having a seat in the sales target space 3 is simply referred to as a “customer”. It is noted that the sales target space 3 is not limited to an indoor space only and it may be an outdoor space.

By referring to the information stored in the storage device 2, the information processing device 1 generates a control signal “Sc” relating to instructions for commodity sales to the self-propelled robot 4, and transmits the control signal Sc to the self-propelled robot 4. As described below, the information processing device 1 determines a commodity (also referred to as the “recommended commodity”) to be recommended to each customer in the sales target space 3, the timing (also referred to as the “recommendation timing”) of recommending the recommended commodity by mobile sales, and the recommendation method, and transmits the control signal Sc specifying the recommended commodity, the recommendation timing, and the recommendation method for each customer to the self-propelled robot 4. The customer is, for example, an employee working in the sales target space 3. Further, the information processing device 1 receives from the self-propelled robot 4 a notification signal “Si” which is a signal for notifying the information processing device 1 of the state of the self-propelled robot 4 and the like.

The storage device 2 stores information necessary for the information processing device 1 to determine the recommended commodity and recommendation timing for each customer. The storage device 2 includes an individual attribute database (DB) 20, a purchase record DB 21, a schedule DB 22, a purchase prediction DB 23, a recommendation method DB 24, and a trial history DB 25.

The individual attribute DB 20 is a database showing the attribute of each individual to be a customer. The purchase performance DB 21 is a database that shows the historical purchase records of each individual to be a customer. The schedule DB 22 is a database showing the schedule of each individual to be a customer. The schedule DB 22 may be, for example, a database of business schedules of employees working in the sales target space 3. In such cases, the scheduling DB 22 shall include information (presence information) indicating the status of the presence of each individual on a daily, hourly, or minute basis, depending on meetings, business trips, or holidays. The presence information is not limited to information indicating the time of presence (or time of absence) in a particular seat for each individual, and may be such information indicating the combination of the position where each individual is located and the time slot at that location. For example, if an individual has multiple workshops, such as desks, laboratories, and shared spaces, the presence information may be information indicative of each workplace in which the individual of is present and the time slot of presence in the each workplace.

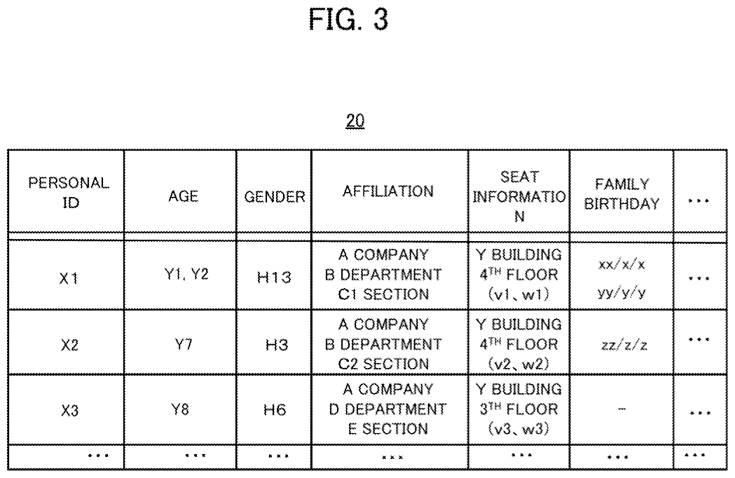

The purchase prediction DB 23 is a database that shows the purchase tendency of commodities for each individual to be a customer. The recommendation method DB 24 is a database that shows the method for recommending a commodity suitable for each individual to be a customer. The trial history DB 25 is a database showing the history of trial results of mobile sales to respective customers by the self-propelled robot 4. Specific examples of the data structure of the purchase performance DB 21, purchase prediction DB 23, the recommendation method DB 24, and the trial history DB 25 will be described later with reference to FIGS. 3 to 7.

The storage device 2 may be an external storage device such as a hard disk connected to or built in to the information processing device 1, or may be a storage medium such as a flash memory that is detachable from the information processing device 1. The storage device 2 may be configured by one or more server devices that perform data communication with the information processing device 1. Each database stored in the storage device 2 may be distributed and stored by a plurality of devices or storage media. Further, the storage device 2 stores the position information indicative of the position where the mobile robot 4 possibly performs the mobile sales. The position where the mobile robot 4 possibly performs the mobile sales is, for example, a position (e.g., meeting room, rest room, and shared space) registered in the schedule DB 22 where each individual is present and within the movable range (i.e. sales target space 3) of the mobile robot 4. For example, this position information is referred to by the self-propelled robot 4 when the self-propelled robot 4 moves to a position where a particular customer is estimated to be present according to the schedule DB 22 and sells a commodity to the customer.

The self-propelled robot 4 autonomously moves in the sales target space 3 and performs the mobile sales of commodities to each customer, based on the control signal Sc transmitted from the information processing device 1. In this case, the self-propelled robot 4 moves in the sales target space 3, and recommends the recommended commodity to each customer according to the recommendation timing and recommendation method specified for each customer. In this case, the mobile robot 4 may receive the position information of each customer from the information processing device 1 by the control signal Sc, or may acquire the position information of each customer by referring to the schedule DB 22 or the like from the storage device 2. The position information of the customer may be information indicative of the seat position in the sales target space 3, or may be a position information based on GPS built into the portable terminal of the customer provided by the company. Further, the position information of the customer may be position information of the customer's portable terminal which is identified based on the signal received from a beacon terminal or a wireless LAN device.

Further, the self-propelled robot 4 includes a commodity holding unit 5 for accommodating the recommended commodities. In the self-propelled robot 4, commodities that are candidates of recommended commodities are accommodated. According to FIG. 1, as an example, the commodity holding unit 5 is a part of the self-propelled robot 4 and has a plate, that is a part of the shelf, configured to slide forward by the drive system of the self-propelled robot 4. In this case, as one example of the commodity recommendation method to be executed when arriving in the vicinity of a customer to be provided with the recommendation commodity, the self-propelled robot 4 performs control so as to shift the plate with the recommended commodity forward. The self-propelled robot 4 may determine the plate to be slid, for example, by recognizing the position of each commodity in the commodity holding unit 5 based on a sensor such as a camera or a RFID reader provided in the commodity holding unit 5 and thereby recognizing the position of the recommended commodity to be recommended to the target customer.

The self-propelled robot 4 also carries out a payout process when the customer purchases the recommended commodity. Further, the self-propelled robot 4 transmits, to the information processing device 1 at a predetermined timing, a notification signal Si for notifying the current state of the self-propelled robot 4 and/or the trial result of the recommendation of the recommended commodity.

Here, an example of a typical flow of commodity sales in the commodity sales promotion system 100 will be described.

For example, before (e.g., the morning of the day) a time period (operation time) in which the mobile robot 4 performs the mobile sales, the information processing device 1 determines one or more combinations of: a customer to be provided with the mobile sales by the mobile robot 4 during the operation time; a recommendation timing; and a recommended commodity. The recommendation timing determined by the information processing device 1 is a time or a time slot (time period) to recommend the recommended commodity to the target customer. Then, for example, the information processing device 1 transmits to the self-propelled robot 4 the control signal Sc indicating a list of the above-described combinations arranged in time series according to the time or time slot indicated by the recommendation timing. Then, the self-propelled robot 4 grasps the schedule of the mobile sales performed by the self-propelled robot 4 on the day, by receiving the control signal Sc described above.

In this case, the information processing device 1 may adjust the recommendation timing so that the time interval between customers which the self-propelled robot 4 approaches in sequence is equal to or longer than a predetermined time length. The predetermined time length described above is determined to be equal to or greater than the total time required to take care of the previous customer and the travel time of the self-propelled robot 4 until it arrives at the next customer. The predetermined time length may be a predetermined time length or may be calculated by the information processing device 1 based on: the position information of each customer to be visited by the self-propelled robot 4 in succession; the moving speed of the self-propelled robot 4; and the time necessary for the purchase of recommended commodity.

Furthermore, the information processing device 1 notifies the commodity manager of the information on the recommended commodities in which the mobile robot 4 performs the mobile sales. The notification may be performed by displaying a list of the determined recommended commodities on a display unit (not shown), or by sending an e-mail indicating a list of recommended commodities to the mail address of the commodity manager. Thereafter, before the mobile robot 4 starts moving sales, the commodity manager receiving the notification of the recommended commodities from the information processing device 1 houses the recommended commodities in the commodity holding unit 5. At the start of the operation time, the mobile robot 4 sets a movement route to arrive at the vicinity of each customer specified by the control signal Sc supplied from the information processing device 1 and moves to arrive at the vicinity of each customer at the recommendation timing for each customer according to the movement route.

If the information processing device 1 detects, as a result of monitoring the state of a customer based on the output of the sensor or the like, the recommendation timing of a recommended commodity to the customer, the information processing device 1 may additionally transmit to the self-propelled robot 4 the control signal Sc indicating additional instructions for the mobile sales to the customer. In this case, the information processing device 1 may transmit the above-described control signal Sc to the self-propelled robot 4 only when determining that the self-propelled robot 4 can perform the above-mentioned additional mobile sales in consideration of the schedule of the mobile sales indicated by the control signal Sc which the information processing device 1 already transmitted to the self-propelled robot 4.

The configuration of the commodity sales promotion system 100 shown in FIG. 1 is an example, and various changes may be made to the configuration. For example, a plurality of the self-propelled robots 4 may receive the control signal Sc transmitted by the information processing device 1. In this case, each of the self-propelled robots 4 receives the control signal Sc from the information processing device 1, respectively, and performs mobile sales based on the received control signal Sc. In this case, for example, when commodities dealt with by each of the self-propelled robots 4 are different, the information processing device 1 determines customers subjected to the mobile sales by each of the self-propelled robots 4, based on the information on the commodities dealt with by each of the self-propelled robots 4 and the recommended commodities for customers. In another example, if the sales target space 3 is divided into the ranges of responsibilities for the self-propelled robots 4, the information processing device 1 determines customers subjected to the mobile sales by each of the self-propelled robots 4 based on the range of responsibility for each of the self-propelled robots 4 and the positional information of each customer. Further, when there are a plurality of self-propelled robots 4, each of the self-propelled robots 4 may directly exchange data with the other self-propelled robots 4. For example, when determining that the communication with the information processing device 1 is impossible, the self-propelled robot 4 may share information by communicating with other self-propelled robots 4 that are within the communicable distance range. Further, the self-propelled robots 4 may communicate and exchange information regarding changes of the ranges of responsibilities within the sales target space 3 with one another. Further, when determining that the communication with the information processing device 1 is impossible, the self-propelled robot 4 may switch to the mobile sales not based on the control signal Sc. In this case, the self-propelled robot 4 makes rounds in the sales target space 3, and sells for a detected person.

Further, the information processing device 1 may be configured by a plurality of devices. In this case, a plurality of devices constituting the information processing device 1 exchange information necessary for executing the pre-allocated processing among the plurality of devices.

(2) Block Configuration

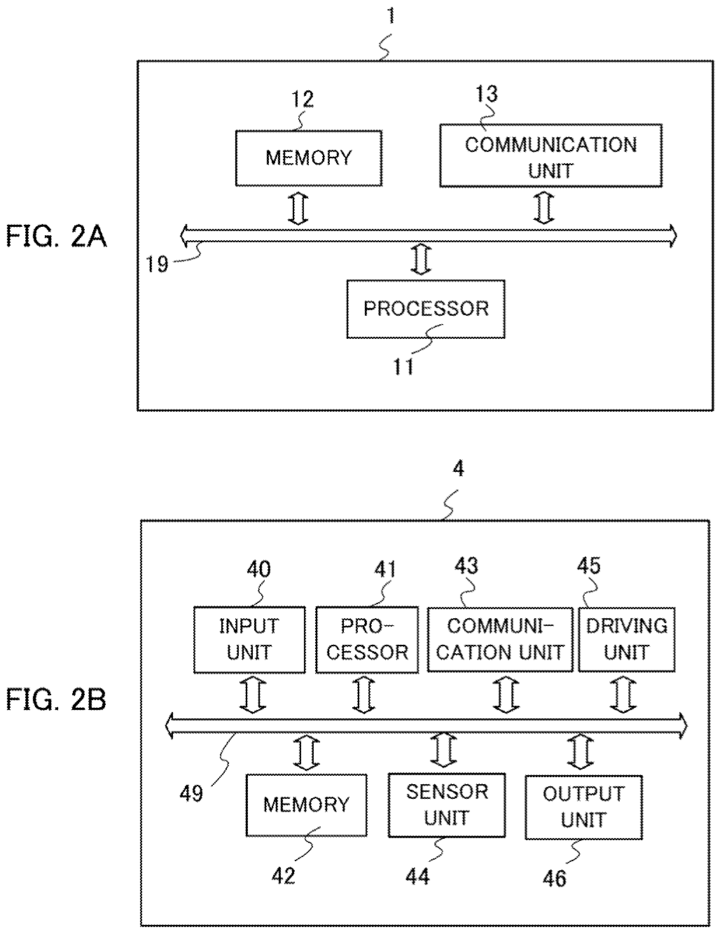

FIG. 2A shows an example of a block configuration of the information processing device 1. The information processing device 1 includes, as hardware, a processor 11, a memory 12, and a communication unit 13. The processor 11, the memory 12, and the communication unit 13 are connected via a data bus 19.

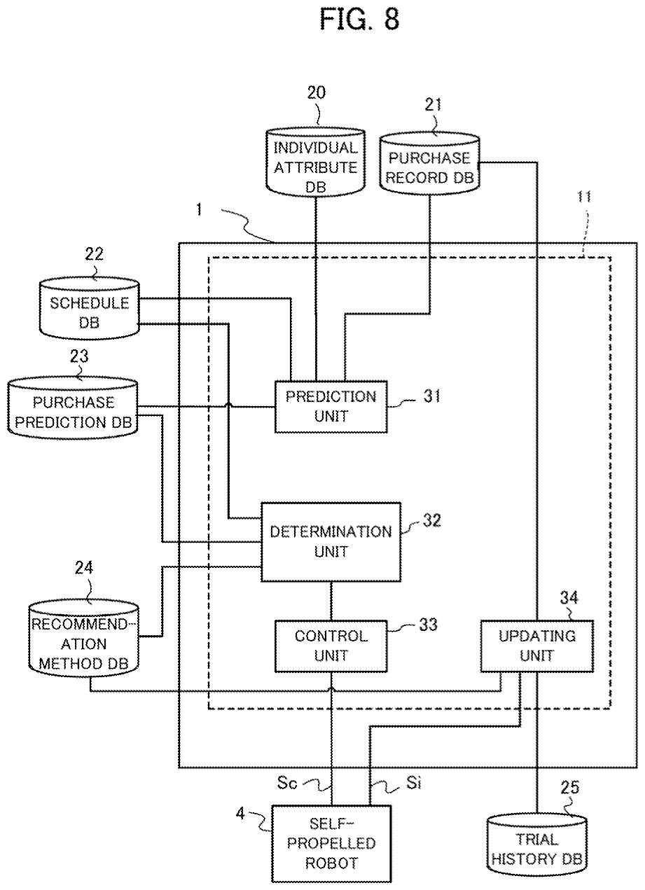

The processor 11 executes a predetermined process by executing a program stored in the memory 12. The processor 11 is one or more processors such as a CPU (Central Processing Unit) and a GPU (Graphics Processing Unit). The process executed by the processor 11 will be described in detail with reference to the functional block diagram shown in FIG. 8.

The memory 12 is configured by various memories such as a RAM (Random Access Memory) and a ROM (Read Only Memory). In addition, a program for executing a predetermined process by the information processing device 1 is stored in the memory 12. The memory 12 is used as a work memory and temporarily stores information acquired from the storage device 2. The memory 12 may function as a storage device 2. Similarly, the storage device 2 may function as a memory 12 of the information processing device 1. The program executed by the information processing device 1 may be stored in a storage medium other than the memory 12.

The communication unit 13 is a communication interface for electrically connecting the information processing device 1 and other devices such as the storage device 2 and the self-propelled robot 4. For example, the communication unit 13 receives the registration information regarding each database stored in the storage device 2 and transmits the update information regarding these databases by communicating with the storage device 2 under the control by the processor 11. Further, the communication unit 13, based on the control by the processor 11, exchanges the control signal Sc and the notification signal Si with the self-propelled robot 4.

Further, the communication unit 13 receives various information (sensing data) relating to the state (sensing) of the customer in the sales target space 3. For example, the communication unit 13 communicates with a sensor such as a camera provided in the sales target space 3, and receives the output information of the sensor. In another example embodiment, the communication unit 13 may receive, from a mobile terminal provided to the customer by the company, the position information based on the GPS (Global Positioning System) built into the mobile terminal together with the identification information of the customer using the mobile terminal. In yet another example, when the customer is an employee of a company that manages the commodity sales promotion system 100, the communication unit 13 may receive historical information relating to e-mails exchanged by the customers and the operation state of business personal computers, from a server device or the like that manages the historical information.

The configuration of the information processing device 1 is not limited to the configuration shown in FIG. 2A. For example, the information processing device 1 may connect to or incorporate at least one of an input unit for receiving an input by a user, a display unit such as a display, or an audio output device such as a speaker. In this case, the information processing device 1 may be a tablet type terminal or the like in which the input function and the output function are integrated with the main body.

FIG. 2B shows an example of the block configuration of the self-propelled robot 4. The self-propelled robot 4 includes, as hardware, an input unit 40, a processor 41, a memory 42, a communication unit 43, a sensor unit 44, a driving unit 45, and an output unit 46. The input unit 40, the processor 41, the memory 42, the communication unit 43, the sensor unit 44, the driving unit 45 and the output unit 46 are connected via a data bus 49.

The input unit 40 is an interface for receiving an input from a customer or an manager of the self-propelled robot 4 or the like, and examples of the input unit 40 include a button, a switch, a touch panel, and a voice input device.

The processor 41 executes a predetermined process by executing a program stored in the memory 42. The processor 41 is one or more processors such as a CPU, a GPU, and the like.

The memory 42 is configured by various memories such as a RAM and a ROM. Further, the memory 42 stores a program for the self-propelled robot 4 to execute a predetermined process. The memory 42 is also used as a working memory.

The communication unit 43 is a communication interface for the mobile robot 4 to communicate with other devices such as the information processing device 1 and the storage device 2. For example, the communication unit 43, under the control by the processor 41, and exchanges the control signal Sc and the notification signal Si with the information processing device 1. Further, the communication unit 43, under the control by the processor 41, communicates with the storage device 2 to thereby receive information necessary for the processor 41 to control the driving unit 45 and the output unit 46 from various sensors provided in the sales target space 3 or each database stored in the storage device 2.

The sensor section 44 includes a variety of internal sensors and external sensors. Examples of the sensor unit 44 include a GPS receiver, an IMU (Inertial Measurement Unit), and camera, a laser range scanner, and other variety of sensors used in a self-position estimation, an obstacle detection, a person detection, a person authentication, or the like.

The driving unit 45 is a drive system that is driven under the control of the processor 41, and includes a drive system related to the traveling of the self-propelled robot 4, and a drive system (including an arm for grasping a commodity and the like) related to the movement of commodities stored in the commodity holding unit 5.

The output unit 46 outputs information under the control of the processor 41. The output unit 46 includes, for example, an audio output unit such as a speaker and a display unit such as a display.

The configuration of the self-propelled robot 4 is not limited to the structure shown in FIG. 2B, and may include any components that a self-propelled robot may have.

(3) Data Structure

FIG. 3 is an example of the data structure of the individual attribute DB 20. The individual attribute DB 20 shown in FIG. 3 is a database that records individual attributes for customers existing in the sales target space 3, and includes items of “PERSONAL ID,” “AGE”, “GENDER”, “AFFILIATION”, “SEAT INFORMATION”, and “FAMILY BIRTHDAY”. The individual attribute DB 20 is suitably used to calculate the purchase tendency of customers recorded in the purchase prediction DB 23 to be described later.

“PERSONAL ID” is identification information of a customer and may be an ID allocated by an organization (company) to which the customer belongs, or may be an ID allocated by a public organization, or may be identification information utilized in biometric certification such as face certification, iris certification, or fingerprint certification. “AGE” and “GENDER” indicate the age and gender of the customer, respectively. “AFFILIATION” indicates the affiliation of the customer. In the example of FIG. 3, in the item “AFFILIATION”, as an example, the company name and the department in the company where the customer belongs is recorded. “SEAT INFORMATION” is information indicating the seat position of the customer. Here, in the item “SEAT INFORMATION”, the building name and the floor where the seat (i.e., the workshop to be the customer's whereabout) of the customer exists, and the two-dimensional coordinates in the floor are recorded. In addition, a plurality of items “SEAT INFORMATION” may be provided, and information indicating the respective seat positions is specified therein when the customer has a plurality of seats (workshops). The seat information is used, for example, as information indicating a destination when the mobile robot 4 performs the mobile sales to the customer. “FAMILY BIRTHDAY” indicates the birthdays of the family of the customer.

The individual attribute DB 20 may include information indicative of the various attributes of each individual, such as family composition (e.g., with or without a spouse), birthday of the customer, anniversaries, hobbies, and the like, in addition to the items shown in FIG. 3. The above-mentioned information is also suitably used in the calculation of the purchase tendency of each customer.

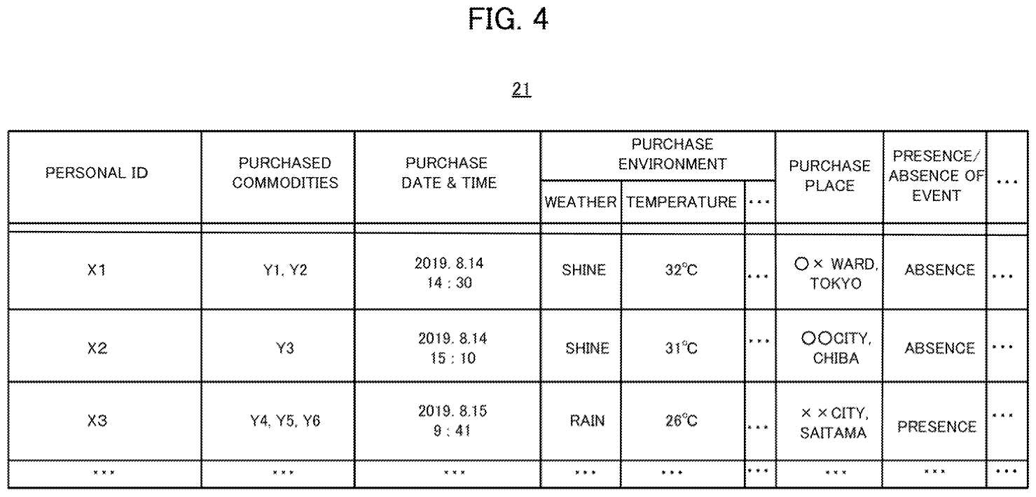

FIG. 4 shows an example of the data structure of the purchase record DB 21. The purchase record DB 21 is a database showing the history of commodity purchase by customers, and has the following items “PERSONAL ID,” “PURCHASED COMMODITIES”, “PURCHASE DATE & TIME”, “PURCHASE ENVIRONMENT”, “PURCHASE PLACE” and “PRESENCE/ABSENCE OF EVENT”.

“PERSONAL ID” is a personal ID indicating a buyer, and is the same type of identification information as the personal ID recorded in the individual attribute DB 20 shown in FIG. 3. “PURCHASED COMMODITIES” indicates information (commodity ID) that identifies the commodities purchased by the customer. “PURCHASE DATE & TIME” indicates the date and time of the purchase. “PURCHASE ENVIRONMENT” indicates the environment at the time of the purchase and includes a sub-item “WEATHER” indicative of the weather at the time of the purchase and “TEMPERATURE” indicative of the outside or indoor air temperature at the time of the purchase. The item “PURCHASE ENVIRONMENT” may have sub-items indicating other environmental indicators such as humidity in addition to “WEATHER” and “TEMPERATURE”. “PURCHASE PLACE” indicates the position where the purchase was made. “PRESENCE/ABSENCE OF EVENT” indicates whether the purchase was accompanied by various events such as a discount campaign. Incidentally, the item “PRESENCE/ABSENCE OF EVENT” may further include information identifying an event such as the category of the event described above.

The purchase record DB 21 may include, for example, sales records of in-house sales purchased associated with the employee certificates or the like of the customers in the commodity sales promotion system 100. Further, the purchase record DB 21 need not be the purchase information relating to commodities managed by the manager (management company) of the commodity sales promotion system 100, and it may include the purchase information relating to commodities managed by those other than the manager. For example, the purchase record DB 21 may include purchase record data collected by major retailers.

Further, as will be described later, in some embodiments, the information processing device 1 adds a record indicating the sales result of the mobile sales by the mobile robot 4 to the purchase record DB 21. In this case, the information processing device 1 adds a record of the purchase record DB 21 based on the notification signal Si supplied from the mobile robot 4. In this case, on the basis of the notification signal Si, the information processing device 1 acquires information on the personal ID of the customer for whom the mobile robot 4 has performed the mobile sales, purchased commodities, purchase date and time, and purchase place. Besides, the information processing device 1 acquires environmental information in the sales target space 3 by communicating with a server device or the like for managing weather information. Then, the information processing device 1 adds the record in which the acquired information is associated to the purchase record DB 21.

Further, the purchase record DB 21 may be further provided with an item indicating whether or not the customer has purchased the commodity. In this case, for example, the information processing device 1 adds to the purchase record DB 21 a record in which the above-described item is set as “PURCHASE” for the sales result when the customer purchases the commodity, and adds to the purchase record DB 21 a record in which the above-mentioned item is set as “NO PURCHASE” for the sales result when the customer recommended with the recommended commodity in the mobile sales does not purchase the recommended commodity. In this case, for example, when updating the purchase prediction DB 23 based on the purchase record DB 21, the information processing device 1 can make a purchase prediction more accurately by considering the item indicating whether or not the customer has purchased the commodity. For example, the information processing device 1 may update the purchase prediction DB 23 so as to exclude such a recommended commodity that was not purchased in the mobile sale from commodities which the target customer tends to purchase.

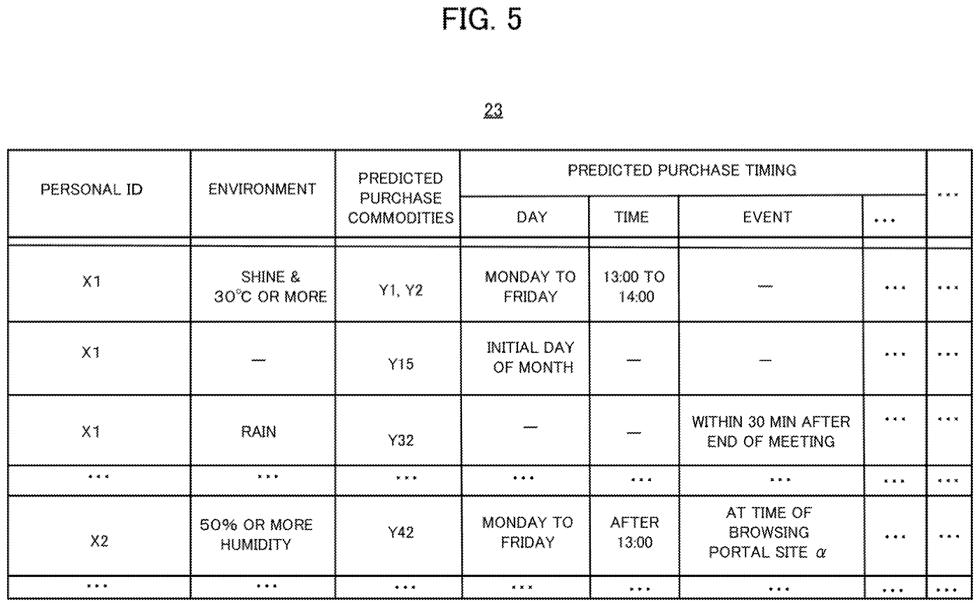

FIG. 5 shows an example of the data structure of a purchase prediction DB 23. The purchase prediction DB 23 has items of “PERSONAL ID”, “ENVIRONMENT”, “PREDICTED PURCHASE COMMODITIES” and “PREDICTED PURCHASE TIMING”. Each record of the purchase prediction DB 23 shows the customer's tendency of purchasing commodities and is generated based on the purchase prediction described later.

“PERSONAL ID” is a personal ID indicating a customer, and is the same type of identification information as the personal ID recorded in the individual attribute DB 20 shown in FIG. 3.

“ENVIRONMENT” indicates the environment in which the purchase of the corresponding purchase commodities is predicted. This environment may be weather (including outside air temperature and humidity, etc.,) in the area where the customer is present, indoor environment around the seat (including room temperature and humidity, etc.) or the like.

“PREDICTED PURCHASE COMMODITIES” indicates information on the identification of commodities that are expected to be purchased by the customer under the environment indicated by “ENVIRONMENT”. Information indicating the category of the commodities that are predicted to be purchased by the customer may be recorded in the “PREDICTED PURCHASE COMMODITIES”. “PREDICTED PURCHASE TIMING” indicates the timing at which the customer is expected to purchase the above-described predicted purchase commodities under the environment indicated by “ENVIRONMENT”.

The item “PREDICTED PURCHASE TIMING” has sub-items “DAY”, “TIME” and “EVENT” which concretely indicate the prediction timing described above. “DAY” indicates the tendency of the day when the customer purchases the predicted purchase commodities. In the item “DAY”, a date specified by the day in units of week may be recorded or the day in units of month or year may be recorded. “TIME” indicates the time or time slot at which the customer tends to purchase the predicted purchase commodities.

“EVENT” indicates an event that the customer tends to purchase the predicted purchase commodities, and the predicted purchase timing based on the event. Examples of the event include any event (business trips, meetings, holidays, etc.,) that can be detected by referring to the schedule DB 22 and any event that can be detected by monitoring a log of a sensor that detects a customer's operation or a log of a business computer. As an example of the former event, the sub-item “EVENT” of the third record of the purchase prediction DB 23 shown in FIG. 5 records information that it is expected to purchase the target predicted purchase commodities within 30 minutes of the meeting termination. Examples of the latter event include customer's browsing of a predetermined website by a business computer that can be monitored by the information processing device 1, the frequency of exchange at an e-mail address granted by the company, a predetermined motion at the time of presence (such as waist or back elongation). For example, if there is a customer who tends to purchase a commodity when there is no exchange of e-mails for a predetermined time or more, the sub-item “EVENT” records that it is predicted that the predicted purchase commodities will be purchased when there is no exchange of e-mails for the predetermined time or more.

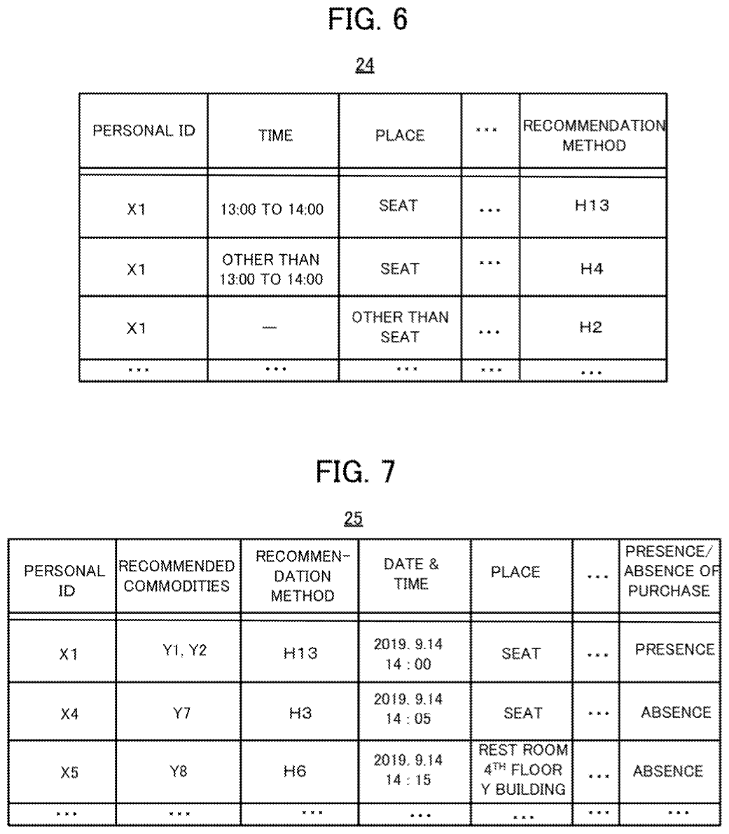

FIG. 6 is an example of a data structure of a recommendation method DB 24. The recommendation method DB 24 is a database showing the recommendation method of the recommended commodity by the self-propelled robot 4 for each individual and for each situation, and it has items of “PERSONAL ID”, “DATE & TIME”, “PLACE”, and “RECOMMENDATION METHOD”.

“PERSONAL ID” is a personal ID indicating a customer to be recommended, and is the same type of identification information as the personal ID recorded in the individual attribute DB 20 shown in FIG. 3. “TIME” indicates the time slot during which commodity the recommendation are to be made according to the corresponding recommendation method. “PLACE” indicates the place where the commodity recommendation is to be made by the corresponding recommendation method. In the example of FIG. 6, information specifying a seat indicated by “SEAT INFORMATION 1”, “SEAT INFORMATION 2”, and the like of the individual attribute DB 20 shown in FIG. 3 is recorded in the item “PLACE”. It is noted that “PLACE” is not limited to the seat assigned to each individual, and may be any place (conference room, rest room, shared space, etc.,) to be used by sharing. In addition to or in place of “DATE & TIME” and “PLACE”, the recommendation method DB 24 may include a variety of items (e.g., recommended commodities or categories thereof) which specify the circumstances under which the self-propelled robot 4 recommends the recommended commodity by the corresponding recommendation method. The recommendation method DB 24 is generated, for example, based on the trial history DB 25 described later.

“RECOMMENDATION METHOD” indicates the recommended method to be implemented for the target customer in the circumstances designated by the items “DATE & TIME” and “PLACE”. This recommendation method is selected from the recommendation methods that the self-propelled robot 4 is able to perform. Each identification number is assigned in advance to each recommendation method that self-propelled robot 4 is able to perform and the identification number indicative of the recommendation method to be executed is recorded in the item “RECOMMENDATION METHOD”. Examples of the recommendation methods that the self-propelled robot 4 is able to perform include: passing through the vicinity of the customer; decelerating in the vicinity of the customer; stopping for a predetermined time in the vicinity of the customer; putting a recommended commodity to the front; displaying or outputting, by audio, information prompting purchase of the recommended commodity; lighting a lamp or the like; and any combination thereof.

The data structure of the recommendation method DB 24 is not limited to the structure shown in FIG. 6. For example, only the recommendation method may be associated with the personal ID in the recommendation method DB 24.

FIG. 7 is an example of the data structure of the trial history DB 25. The trial history DB 25 is a database representing the trial history of mobile sales to customers by the self-propelled robot 4, and has items of “PERSONAL ID,” “RECOMMENDED COMMODITIES”, “RECOMMENDATION METHOD”, “DATE & TIME”, “PLACE” and “PRESENCE/ABSENCE OF PURCHASE”.

“PERSONAL ID” is a personal ID indicating a customer who was subject to mobile sales, and is the same type of identification information as the personal ID recorded in the individual attribute DB 20 shown in FIG. 3. “RECOMMENDED COMMODITIES” indicates commodities recommended by the self-propelled robot 4 to the customer. “RECOMMENDATION METHOD” indicates the recommendation method for the recommended commodities by the self-propelled robot 4 for the customer. “DATE & TIME” indicates the date and time when the self-propelled robot 4 tried to sell recommended commodities to the customer. “PLACE” indicates the place where the self-propelled robot 4 tried to sell recommended commodities to the customer. “PRESENCE/ABSENCE OF PURCHASE” indicates whether the recommended commodities were purchased or not when the mobile robot 4 tried to sell the recommended commodities to the customer.

The information processing device 1 generates a record to be registered in the trial history DB 25 each time the notification signal Si indicating the trial result of the mobile sales is received from the mobile robot 4. In this case, after the trial of the mobile sales of the recommended commodities, the self-propelled robot 4 transmits to the information processing device 1 the notification signal Si indicating the personal ID of the customer, the date and time and the position of the trial of the mobile sales, and information indicative of the presence/absence of the purchase as a trial result.

(4) Functional Block

FIG. 8 is an example of a functional block of the information processing device 1. The processor 11 of the information processing device 1 functionally includes a prediction unit 31, a determination unit 32, a control unit 33, and an updating unit 34.

The prediction unit 31 makes a purchase prediction (i.e., estimation of purchase tendency) for customers in the sales target space 3 using the individual attribute DB 20 and the purchase record DB 21, and registers the prediction result in the purchase prediction DB 23. In this case, the prediction unit 31 may make the purchase prediction for the customers based on various prediction analysis techniques. For example, the prediction unit 31 uses a prediction analysis automation technique that realizes a series of process automation from the extraction/design of data items (feature quantities) valid for the analysis of the individual attribute DB 20 and the purchase record DB 21 to the creation of an optimal prediction model for commodities (“PREDICTED PURCHASE COMMODITIES” in the purchase prediction DB 23) for which the purchase is predicted and the timing (“PREDICTED PURCHASE TIMING” in the purchase prediction DB 23) at which the commodities are predicted to be purchased. Examples of a software for performing such predictive analytical automation include dotData (registered trademark). In another example, the prediction unit 31 may analyze the purchase commodities and the purchase timing that each customer is predicted to purchase based on the heterogeneous mixture learning technique, which is an analytical technique that automatically discovers a large number of regularities mixed in the big data. In yet another example, the prediction unit 31 may use a customer analysis technique which automatically extracts groups having strong relationships between customers and commodities from the purchase record DB 21, etc., and which determines the commodities and the purchase timing that each customer is predicted to purchase based on the features of each extracted group.

In some embodiments, the prediction unit 31 may further refer to the schedule DB 22 to predict the purchase commodities and purchase timing of for the customers. In this case, the prediction unit 31 determines the relationship between events such as a meeting and a business trip registered in the schedule DB 22 and purchase records registered in the purchase record DB 21. Then, the prediction unit 31 determines an event related to the purchase records and makes a prediction of the recommendation timing by using the occurrence time of the event as a reference time. Thereby, the prediction unit 31 can suitably record, in the purchase prediction DB 23, the recommendation timing based on the occurrence time of the event related to the commodity purchase by the customers.

On the basis of the schedule DB 22 and the purchase prediction DB 23, the determination unit 32 determines a target customer of mobile sales, a recommended commodity and a recommendation timing corresponding to the target customer. For example, when determining the sales schedule of the day for the self-propelled robot 4 prior to the operation time of the self-propelled robot 4, the determination unit 32 first recognizes the customers and the time slot (time period) in which the self-propelled robot 4 is present in the mobile sales place (i.e., within the sales target space 3), by referring to the schedule DB 22. The place where the customer is present in the sales target space 3 may be, for example, a customer's seat (including a lab or other workshop), or may be a rest room, meeting room, or other shared space used by the customers. Then, the determination unit 32 recognizes one or more customers who are predicted to purchase commodities in the time slot (on the present date) in which the customers are present in the sales target space 3, by referring to the purchase prediction DB 23. Then, the determination unit 32 determines the recommendation timing to be the timing at which the purchase by the recognized customer is predicted and determines the recommended commodity to be the predicted purchase commodity. If the recognized timing at which the customers are predicted to purchase indicates a particular time, the determination unit 32 may determine the recommendation timing to be a time slot having predetermined time lengths before and after the above-mentioned particular time. Thereby, the determination unit 32 lets the recommendation timing have a width thereby to provide flexibility in the mobile schedule of the self-propelled robot 4.

Further, the determination unit 32 refers to the recommendation method DB 24 to determine the recommendation method for a customer determined as a mobile sales target. In this case, for example, the determination unit 32 determines the recommendation method for the customer determined as the mobile sales target to be the recommendation method associated with the individual ID of the above customer in the recommendation method DB 24. In addition, when the recommendation method DB 24 includes items that specify conditions such as the date & time and place, the determination unit 32 further refers to the date & time and place and the like at the time of moving sales to determine the recommendation method for the target customer. If the recommendation method for the target customers is not recorded in the recommendation method DB 24, the determination unit 32 executes any recommendation method selected from feasible recommendation methods. For example, the determination unit 32 may perform a predetermined recommendation method or may perform a recommendation method selected at random from the feasible recommendation methods. In another example, the determination unit 32 may use the most common recommendation method registered in the recommendation method DB 24 as the recommendation method to be performed.

In addition, if the day on which sales is performed by the self-propelled robot 4 falls under the birthday or other anniversary of the family of the customer recorded in the individual attribute DB 20, the determination unit 32 may use a travel ticket, a flower gift ticket, or the like as the recommended commodity, and use the presence time slot of the customer as the recommendation timing. In this case, the determination unit 32 may specify a commodity other than the commodities already purchased on the anniversary date by the customer if the information on the commodities purchased by the customer in the past is recorded in the purchase performance DB 21.

In the case where the customer is an employee, the determination unit 32 may determine the recommendation timing to be a timing at which the customer takes a rest or a timing at which the business efficiency decreases. In this case, for example, the determination unit 32 receives the sensing data such as the image data of the customer, the web browsing history of the customer during the business, the customer's exchange status of e-mails, and the like from the customer's company system or the like, and analyzes them to detect the timing at which the customer performs a rest or the timing at which the business efficiency decreases. Then, if the determination unit 32 detects the presence of such a customer that has become any of these timings, the determination unit 32 causes the control unit 33 to transmit the control signal Sc for notifying that the recommendation timing for the customer. The recommended commodity in this case may be any commodity housed in the commodity holding unit 5, or may be a commodity which corresponds to a purchase record of the target customer among the commodities housed in the commodity holding unit 5. Similarly, on the basis of the sensing data of the customer, the prediction unit 31 may predict the timing (time or time slot) at which the customer is predicted to take a rest or the timing at which the business efficiency is predicted to decrease as “PREDICTED PURCHASE TIMING” in the purchase prediction DB 23, and may record the predicted result in the purchase prediction DB 23.

The control unit 33 generates the control signal Sc indicating the combination of the customer, the recommended commodity, the recommendation timing, and the recommended method which are determined by the determination unit 32, and transmits the generated control signal Sc to the self-propelled robot 4. Thereafter, during a predetermined activity time, the self-propelled robot 4, which has received the control signal Sc, performs the mobile sales of the recommended commodity for the customer according to the recommendation timing and recommended method specified by the control signal Sc.

The updating unit 34 updates the purchase record DB 21 based on the notification signal Si indicating the sales result by the self-propelled robot 4 supplied from the self-propelled robot 4. In this case, for example, the updating unit 34 registers the purchase result for commodities purchased by the mobile sales in the purchase record DB 21. In another example, in addition to the above-described purchase result, the updating unit 34 registers a result of the mobile sales regarding recommended but not sold commodities in the purchase record DB 21.

Further, the updating unit 34 updates the trial history DB 25 based on the notification signal Si. Further, the updating unit 34 updates the recommendation method DB 24 based on the trial history DB 25 at a predetermined timing. In this case, the updating unit 34 determines the optimal recommendation method for each customer based on, for example, recommendation methods for each customer registered in the trial history DB 25 and the result (i.e., presence or absence of purchase). For example, the updating unit 34 determines the optimal recommendation method to be the recommendation method having the highest success rate (probability that the purchase has been performed) equal to or higher than a predetermined rate among tried recommendation methods or may determine the optimal recommendation method to be a recommendation method determined by a general machine learning approach. In addition, if the optimal recommendation method are different among individuals depending on the time slot and/or place, the updating unit 34 determines the recommendation optimal method with respect to each customer and each situation.

(5) Processing Flow

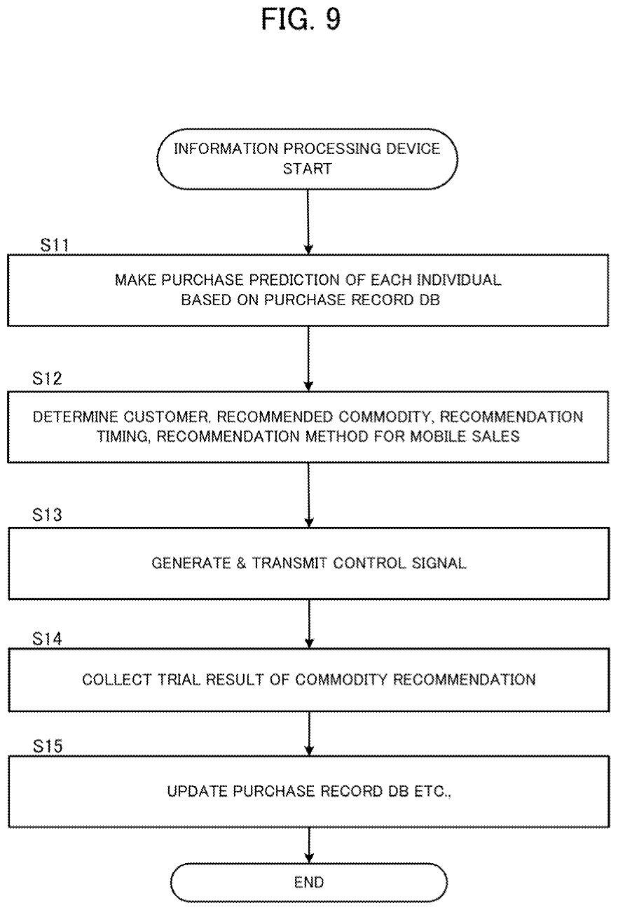

FIG. 9 is an example of a flowchart showing a processing procedure executed by the information processing device 1 according to the first example embodiment.

First, the prediction unit 31 of the information processing device 1 makes a purchase prediction for each individual based on the purchase record DB 21 (step S11). In this case, the prediction unit 31 predicts the purchase commodities (“PREDICTED PURCHASE COMMODITIES” in the purchase prediction DB 23) and the purchase timing (“PREDICTED PURCHASE TIMING” in the purchase prediction DB 23) for each individual, and stores the predicted result in the purchase prediction DB 23. At this time, in some embodiments, the prediction unit 31 further refers to the individual attribute DB 20 in addition to the purchase record DB 21 thereby to make a purchase prediction further considering the individual attribute.

Next, the determination unit 32 determines the target customer of the mobile sales by the self-propelled robot 4, the recommended commodity recommended to the customer, the recommendation timing and the recommended method (step S12). In this case, for example, the determination unit 32 determines the above-described customer, recommended commodity and recommendation timing based on: the purchase prediction result of each individual stored in the purchase prediction DB 23 at step S11; the presence information of each individual stored in the schedule DB 22; and the environmental information such as weather and indoor temperature. Further, the determination unit 32 uses the recommendation method associated with the personal ID indicative of the determined customers in the recommendation method DB 24 as the recommendation method to be executed. Here, a specific example of a method for determining the recommended commodity will be supplementally described. For example, if there is a new commodity whose category is similar to the category of the previously-purchased commodity by the customer indicated by the purchase record DB 21, the determination unit 32 may determine the recommended commodity to be the new commodity. In another example, the determination unit 32 may determine the recommended commodity to be a commodity purchased recently by another customer having a purchase record similar to the purchase record of the target customer. In yet another example, the determination unit 32 may determine the recommended commodity to be such a commodity that conforms to the preference of the target customer but has not yet been purchased by the target customer as a result of various analyses.

Then, the control unit 33 generates the control signal Sc indicative of one or more combinations of the customer, recommended commodity, recommendation timing, and recommended method which are determined at step S11 by the determination unit 32, and then transmits the control signal Sc to the self-propelled robot 4 (step S13). In this case, by referring to the presence information corresponding to the target customer from the schedule DB 22, the control unit 33 may include, in the control signal Sc, the information indicative of the position where the target customer is present at the time of the recommendation timing. Further, in this case, the control unit 33 may adjust the recommendation timing specified to the control signal Sc so that the interval between the recommendation timings at which the self-propelled robot 4 visits customers continuously is longer than a predetermined time length. Specifically, the control unit 33 may adjusts the recommendation timings for one or more customers so that each time interval of the recommendation timings is equal to or longer than the predetermined time length described above. The control unit 33 may determine the above-described predetermined time length to be a predetermined time length or may calculate the predetermined time length based on: the seat information of each customer to which the self-propelled robot 4 visits continuously; the moving speed of the self-propelled robot 4; and the time required for purchase of the recommended commodity. Thereafter, the self-propelled robot 4, which has received the control signal Sc, recommends the recommended commodity to the customer specified by the control signal Sc, according to the specified recommendation timing and specified recommended method.

Next, the updating unit 34 collects the trial result of the recommendation of the recommended commodity by the self-propelled robot 4 (step S14). Specifically, the updating unit 34 receives, from the self-propelled robot 4 via the communication unit 13, the notification signal Si including the trial result of the recommendation of recommended commodities by the self-propelled robot 4 (such as the presence/absence of purchase of the recommendation commodity). The notification signal Si may include information indicating the execution date and time (i.e., execution timing) or the like of the recommendation of the recommended commodity. The notification signal Si may not only include the presence/absence of purchase of the recommendation commodity but also include the presence/absence of purchase of commodities other than the recommendation commodity. Then, the updating unit 34 stores the collected trial result of the recommendation of the recommendation commodity in the trial history DB 25 in association with information indicative of the recommended customer, the recommended commodity, the recommendation timing and the recommendation method. Incidentally, the update unit 34 may receive the control signal Sc including information such as the recommended commodity and the recommended method from the control unit 33 which generates the control signal Sc, instead of obtaining information relating to the recommended commodity and the recommended method from the mobile robot 4 by the notification signal Si.

Next, the updating unit 34 updates the purchase record DB 21 and the like at a predetermined timing (step S15). In this case, for example, the updating unit 34 adds, to the purchasing result DB 21, a purchase record specified based on the trial result of the recommendation of the recommended commodity collected at step S14, is added. In addition, the updating unit 34 updates the recommendation method DB 24 based on the trial history DB 25 in which the performed recommendation method is at least associated with and the presence/absence of purchase by the recommendation method.

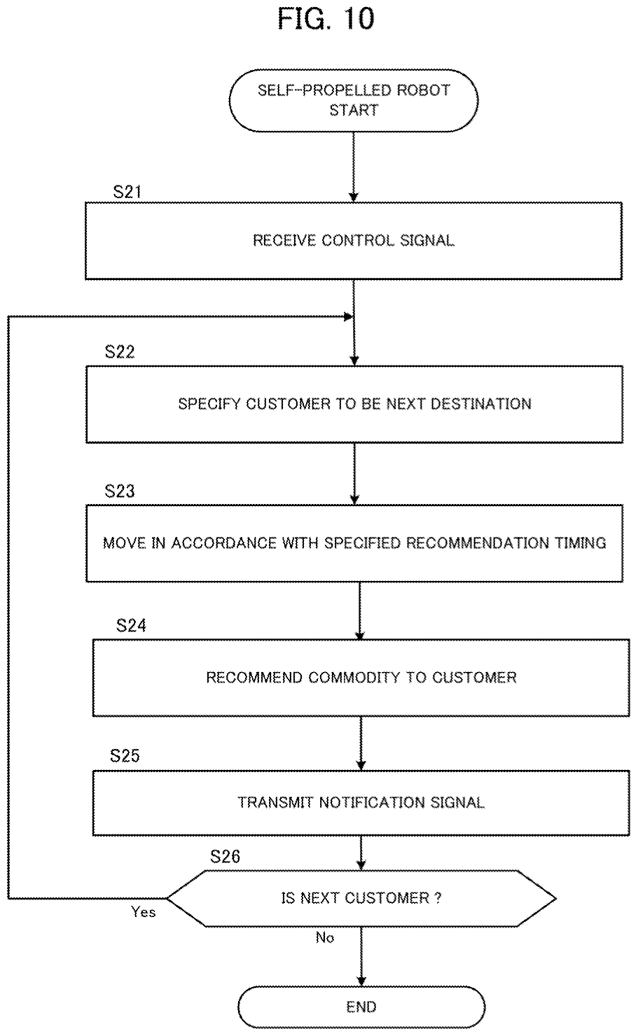

FIG. 10 is an example of a flowchart illustrating a processing procedure to be executed by the self-propelled robot 4 in the first example embodiment.

First, the self-propelled robot 4 receives the control signal Sc from the information processing device 1 via the communication unit 43 (step S21). Then, the self-propelled robot 4 specifies the customer to be the next movement destination, based on the received control signal Sc (step S22).

Then, the self-propelled robot 4 moves to the vicinity of the customer specified at step S22 in accordance with the recommendation timing specified by the control signal Sc (step S23). In this case, the self-propelled robot 4 receives, for example, the target customer's seat information or position information from the information processing device 1, the storage device 2, or another device for managing these information, and controls the driving unit 45 so as to approach the position indicated by the received information. Here, if the time to the recommendation timing for the target customer is longer than the movement time of the self-propelled robot 4 to be estimated to the target customer, the self-propelled robot 4 may wait a predetermined standby place specified in advance (e.g., corridor) for a necessary time, for example. In another example, the self-propelled robot 4 may move to the vicinity of the person detected by the sensor unit 44 and perform an autonomous commodity sales not based on the control signal Sc.

When the self-propelled robot 4 arrives in the vicinity of the target customer at the recommendation timing specified, the self-propelled robot 4 performs the recommended method specified by the control signal Sc by controlling the output unit 46 (step S24). In this case, the self-propelled robot 4 may perform a biometric authentication such as face authentication, iris authentication, or fingerprint authentication of the customer based on the output of the sensor unit 44, and further perform processing or the like for determining whether or not it has arrived at the vicinity of the target customer. The above-described biometric authentication is not limited to the above example, and it may be any biometric authentication using information of a human body characteristic (biological organ) or a behavior characteristic (habit). Such biometric certification also includes anthropomorphic certification based on the human body shape (body size) and the like. Then, if the self-propelled robot 4 recognizes the customer's intention for purchasing the recommended commodity based on the output data of the sensor unit 44 or the input unit 40, it performs a paying procedure for the purchase of the commodity. In this case, the paying method may be an electronic payment method utilizing a short-range wireless communication (NFC) or a two-dimensional bar code, or may be a payment method based on biometric certification, or may be a credit card payment or a cash payment.

Thereafter, the self-propelled robot 4, through the communication unit 43, transmits a notification signal Si indicating the sales result of the recommended commodity to the information processing device 1 (step S25). In this case, the self-propelled robot 4 may transmit to the information processing device 1 the notification signal Si indicating the result of the commodity recommendation every time it conducts the commodity recommendation at step S24, or may transmit to the information processing device 1 the notification signal Si indicating all sales results of the day at the end of the mobile sales of the day.

Then, the self-propelled robot 4 determines whether or not there is a customer designated as the next destination of the self-propelled robot 4 (step S26). When there is a customer designated as the destination of the mobile robot 4 (step S26; Yes), the self-propelled robot 4 returns the process to step 22 and performs the processing necessary for the mobile sales to the customer serving as the next sales destination. On the other hand, if there is no customer specified as the next destination of the self-propelled robot 4 (Step S26; No), the self-propelled robot 4 terminates the processing of the flowchart. In this case, for example, the self-propelled robot 4 moves to the designated standby position. In another example, the self-propelled robot 4 may move around in the sales target space 3 until the end of the activity time and continue the mobile sales not based on the control signal Sc. In this case, when the self-propelled robot 4 detects a predetermined voice or operation based on the input to the input unit 40 or the output of the sensor unit 44, it moves to the vicinity of a person who has performed the generation source or operation of the voice and prompts the purchase of any commodities in the commodity holding unit 5. Further, when the next control signal Sc is received from the information processing device 1, the self-propelled robot 4 starts the flowchart of FIG. 10 again.

As described above, according to the present example embodiment, the commodity sales promotion system 100 can perform mobile sales that meet the needs of individual customers in accordance with the timing when individual customers require them. Thereby, it is possible to suitably prompt customer to purchase commodities in the sales target space 3. On the other hand, conventionally, even if it knew commodities customers want, it could not sell them at the timing they wanted, which resulted in a loss of sales opportunities. According to the present example embodiment, it is possible to suitably suppress the occurrence of loss of such sales opportunities. Further, the commodity sales promotion system 100 performs the mobile sales by the self-propelled robot 4 to thereby suitably attract attention to commodities to be sold while reducing the labor cost. In addition, the commodity sales promotion system 100 allows the self-propelled robot 4 to perform commodity recommendations according to the recommendation method learned for each customer, thereby favorably raising the customer's purchasing willingness.

(6) Modification

Next, modifications suitable for the first example embodiment described above will be described. The modifications described below may be applied to the first example embodiment described above in arbitrary combination.

(First Modification)

The information processing device 1 may instead execute a part of the processing to be performed by the processor 41 of the self-propelled robot 4. For example, instead of transmitting the control signal Sc indicating a combination of recommended commodity and recommendation timing and the like, the information processing device 1 may transmit to the self-propelled robot 4 the control signal Sc for specifically instructing the operation to be executed by the self-propelled robot 4 based on the combination.

The present modification will be described with reference again to the functional block of FIG. 8. After the determination, made by the determination unit 32, regarding the customer, recommended commodity and recommendation timing for mobile sales by the self-propelled robot 4 in the same manner as in the above-described example embodiment, the control unit 33 generates the control signal Sc instructing the operation to be executed by the self-propelled robot 4. In this case, for example, the control unit 33 receives the information generated by the sensor unit 44 of the self-propelled robot 4 and the notification signal Si indicating the information generated by the input unit 40 from the self-propelled robot 4, and recognizes the state of the self-propelled robot 4 and the state around the self-propelled robot 4. Then, for example, the control unit 33 determines the traveling path of the self-propelled robot 4, and transmits the control signal Sc for moving the self-propelled robot 4 along the traveling path. In this case, the control unit 33 generates the control signal Sc based on: information indicative of the layout of the sales target space 3 stored in advance in the storage device 2; seat information of the customer; position information based on the GPS or the like of a terminal used by the customer; and/or information generated by the input unit 40 and the sensor unit 44. In another example, the control unit 33 transmits the control signal Sc instructing the self-propelled robot 4 to execute the recommendation method in the vicinity of the customer. In yet another example, the control unit 33 also performs the authentication process of the customer based on the output of the sensor unit 44 or the like, and an accounting process at the time of commodity purchase.

According to this modification, the information processing device 1 can also let the self-propelled robot 4 suitably perform the mobile sales at appropriate timings for the individual customers.

(Second Modification)

The self-propelled robot 4 may be used not only for the mobile sales to employees or the like whose workplace is the sales target space 3 but also for the mobile sales in which the sales target space 3 is an in-flight, inboard, or in-vehicle.

In this case, the schedule DB 22 records the seat information indicative of the seat allocated for each passenger. For example, when the self-propelled robot 4 is used for in-vehicle sales, the schedule DB 22 records the riding section of the reservation person for each seat. Then, for example, on the basis of the information generated by the sensor such as a camera provided in the sales target space 3, the information processing device 1 generates the presence information by determining the presence/absence of each seat, and/or identify the personal ID by face recognition or the like of the passenger. Then, the information processing device 1 refers to the individual attribute DB 20 and the purchase record DB 21 based on the personal ID identified based on the output of the sensor or the reservation information or the like, recognizes the individual attribute corresponding to each passenger and the sales record, and makes substantially the same purchase prediction as in the above-described example embodiment. Then, the information processing device 1 updates the purchase prediction DB 23 based on the prediction result, and determines the recommended commodity, recommendation timing, and recommendation method for passengers in the seats. Then, the information processing device 1 transmits the control signal Sc indicating these determined information to the self-propelled robot 4.

In this way, for mobile sales whose sales target space 3 is in-flight, inboard, or in-vehicle, the information processing device 1 can suitably let the self-propelled robot 4 perform the mobile sales at timing in accordance with the individual customers.

On the basis of information of an IC card used when the passenger rides in the sales target space 3, the information processing device 1 may recognize the presence/absence of boarding in the sales target space 3 of the reservation person of each seat and may determine that passengers who boarded in the sales target space 3 sit in their reserved seats. Also in this case, by acquiring the seat information of the passenger in each seat, the information processing device 1 can suitably determine the recommendation timing belonging to the time slot in which the passenger is present.

(Third Modification)

The self-propelled robot 4 may have one or more function of the information processing device 1 instead.

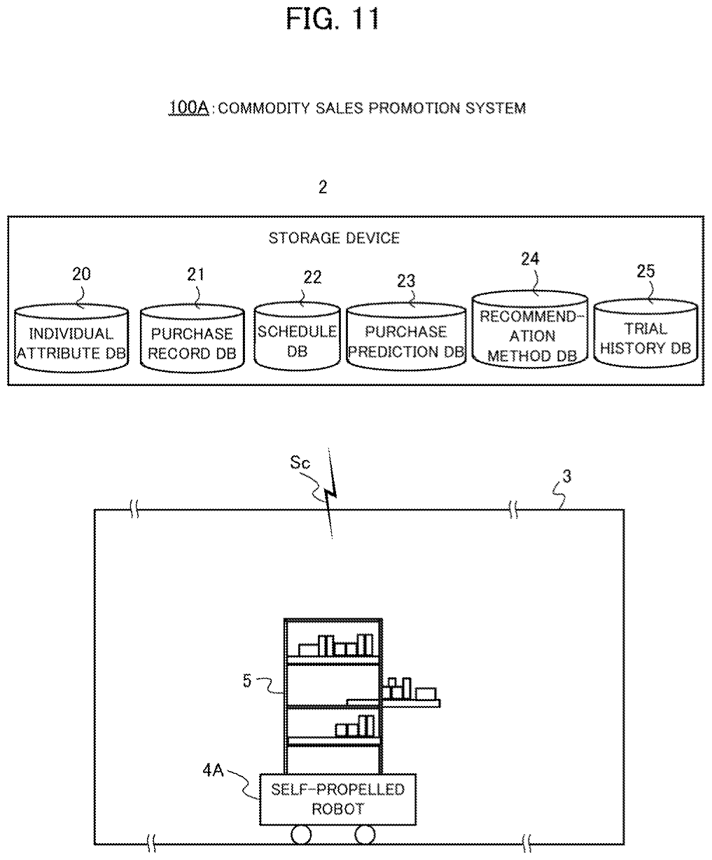

FIG. 11 shows a schematic configuration of a commodity sales promotion system 100A according to the third modification. The commodity sales promotion system 100A has a storage device 2 and a self-propelled robot 4A. In this case, the self-propelled robot 4A incorporates one or more process units that execute processing executed by the information processing device 1 shown in FIG. 1, and performs data communication with the storage device 2 to refer to and update the respective databases of the storage device 2. The self-propelled robot 4A also refers to the respective databases of the storage device 2 and autonomously executes mobile sales in accordance with individual customers.

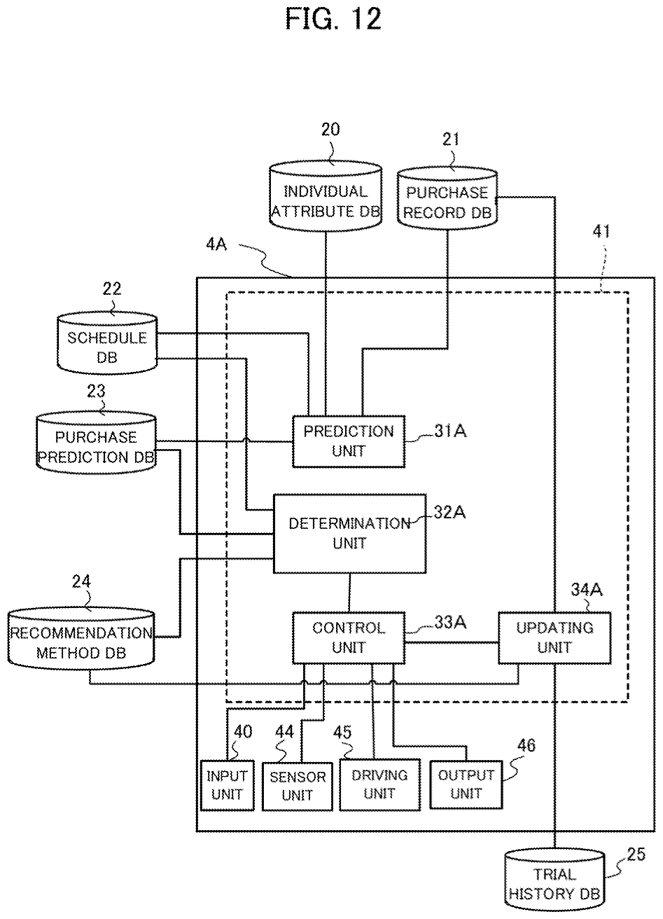

FIG. 12 shows a functional block of the processor 41 of the self-propelled robot 4A. The processor 41 functionally includes a prediction unit 31A, a determination unit 32A, a control unit 33A, and an updating unit 34A. Here, the prediction unit 31A and the determination unit 32A perform the same process as the process performed by the prediction unit 31 and the determination unit 32 of the information processing device 1 illustrated in FIG. 8.

The control unit 33A controls the driving unit 45 and the output unit 46 based on: a combination of the target customer of the sales determined by the determination unit 32A, the recommended commodity, and the recommendation timing; and the information outputted by the input unit 40 and the sensor unit 44. The process performed by the control unit 33A is the same as the processing performed based on the control signal Sc by the processor 41 of the mobile robot 4 of the commodity sales promotion system 100 described above. For example, the control unit 33A determines the traveling path of the self-propelled robot 4 and controls the driving unit 45 to drive the self-propelled robot 4 along the path and controls the output unit 46 to perform an output based on the recommendation method determined by the determination unit 32A when it arrives in the vicinity of the customer.

The updating unit 34A determines whether or not the recommended commodity is sold by detecting the presence/absence of the settlement of the recommended commodity, and, based on the determination result, updates the purchase record DB 21 and the trial history DB 25 in the same manner as the updating unit 34 shown in FIG. 8 does. Further, the updating unit 34A updates the recommendation method DB 24 based on the updated trial history DB 25 in the same manner as the updating unit 34 does.

In this way, the processor 41 of the self-propelled robot 4A in this modification also functions as the information processing device 1 described above. Then, the self-propelled robot 4A according to the present modification can autonomously execute the mobile sales at a timing in accordance with individual customers without depending on the control by other devices.

(Forth Modification)

Instead of controlling the self-propelled robot 4, the information processing device 1 may propose or specify a recommended commodity and a recommendation timing for each customer to a seller who performs mobile sales in the sales target space 3.

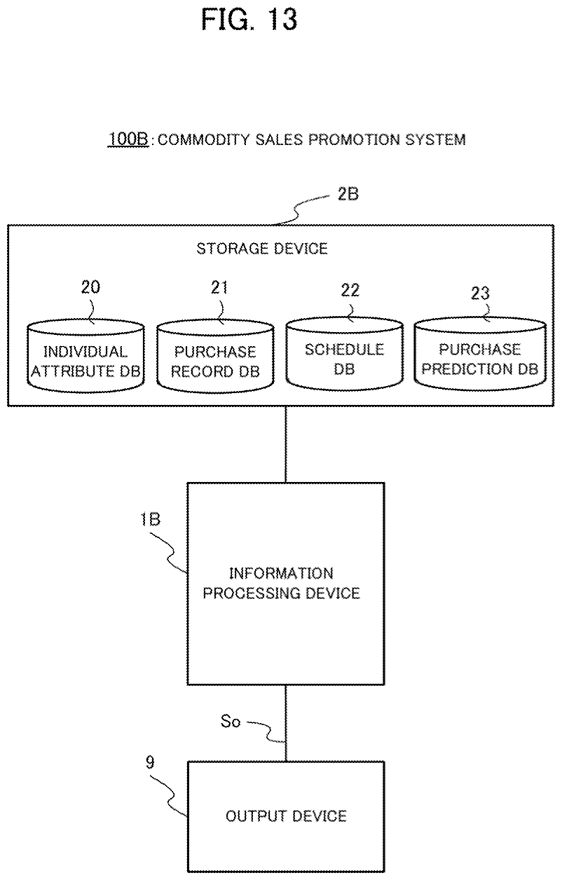

FIG. 13 shows a configuration example of a commodity sales promotion system 100B according to the fourth modification. The commodity sales promotion system 100B according to the fourth modification includes an information processing device 1B, a storage device 2B, and an output device 9.

The information processing device 1B determines the recommended commodity and recommendation timing for each customer by referring to the individual attribute DB 20, the purchase record DB 21, the schedule DB 22 and the purchase prediction DB 23 of the storage device 2B. Then, the information processing device 1B supplies the output device 9 with an output signal “So” for instructing the output of the combination of the determined recommended commodity and the recommendation timing and information (e.g., attribute information such as the name of the customer or/and the position information in the sales target space 3) identifying the target customer of sales.

The output device 9 at least includes one of a sound output unit for outputting sound or a display unit such as a display, and performs an output based on the output signal So supplied from the information processing device 1B. In this case, on the basis of the output signal So, the output device 9 displays or outputs, by audio, the information identifying the target customer of sales and information indicative of the combination of the recommended commodity and recommendation timing. In this case, the output device 9 may be a portable terminal used by the seller or may be a display or the like installed in the standby station of the seller.

Thus, according to the present modification, the information processing device 1B can suitably propose or specify, through the output device 9, the sales of the recommended commodity at a timing suitable for the individual customers to the seller performing the mobile sales in the sales target space 3. This allows the seller to perform mobile sales that meets the needs of individual customers when they need them.

The output device 9 may be a printing machine. In this case, the output device 9 outputs a print paper indicating the information identifying the target customer of sales and information indicative of the combination of the recommended commodity and recommendation timing. Further, the information processing device 1B may transmit information equivalent to the output signal So to the communication address such as the e-mail address used by the seller, instead of presenting the recommended commodity and recommendation timing for each customer by the output device 9.

### Second Example Embodiment

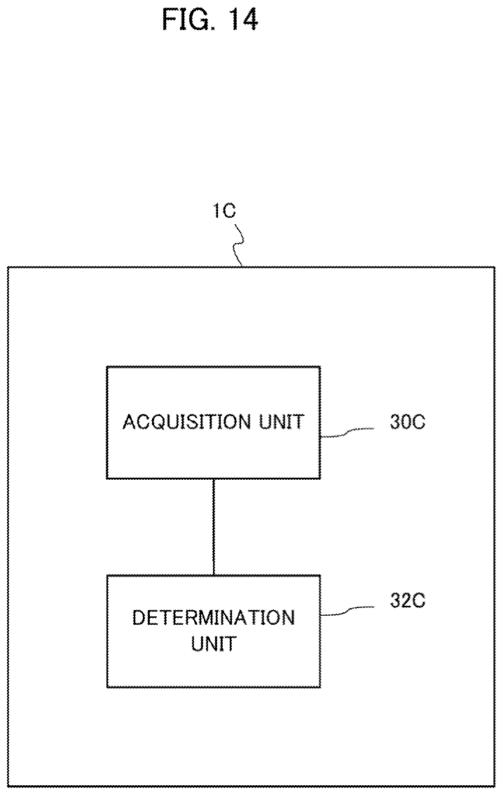

FIG. 14 is a schematic configuration diagram of an information processing device 1C according to a second example embodiment. As shown in FIG. 14, the information processing device 1C mainly includes an acquisition unit 30C and a determination unit 32C.

The acquisition unit 30C acquires at least one of purchase record information indicative of a purchase record or the individual attribute information relating to an attribute of a customer who is a subject of mobile sales of a commodity, and presence information relating to a presence of the customer, the purchase record including a date and time of a purchase by the customer. The purchase result information corresponds to, for example, the information stored in the purchase record DB 21 according to the first example embodiment, the presence information corresponds to, for example, the information stored in the schedule DB 22 according to the first example embodiment.

The determination unit 32C determines, based on at least one of the purchase record information or the individual attribute information and the presence information, a timing of moving sales of a recommended commodity to be recommended to the customer. For example, the determination unit 32C is realized by the determination unit 32 according to the first example embodiment.

According to the configuration of the second example embodiment, the information processing device 1C can suitably determine the timing of the mobile sales of the recommended commodity to be recommended to a customer.

The whole or a part of the example embodiments described above can be described as, but not limited to, the following Supplementary Notes.

[Supplementary Note 1]

An information processing device comprising:

an acquisition unit configured to acquire
at least one of purchase record information indicative of a purchase record or the individual attribute information relating to an attribute of a customer who is a subject of mobile sales of a commodity
and presence information relating to a presence of the customer,

the purchase record including a date and time of a purchase by the customer; and

a determination unit configured to determine, based on at least one of the purchase record information or the individual attribute information and the presence information, a timing of moving sales of a recommended commodity to be recommended to the customer.

[Supplementary Note 2]

The information processing device according to Supplementary Note 1,

wherein the acquisition unit further acquires environmental information relating to environment in which the customer is present, and

wherein the determination unit determines the timing based on the environmental information, at least one of the purchase result information or the individual attribute information, and the presence information.

[Supplementary Note 3]

The information processing device according to Supplementary Note 1 or 2, further comprising

a control unit configured to transmit a control signal for instructing a self-propelled robot having at least the recommended commodity to recommend the recommended commodity to the customer according to the timing.

[Supplementary Note 4]

The information processing device according to Supplementary Note 1 or 2,

wherein the information processing device is incorporated in a self-propelled robot which has at least the recommended commodity,

the information processing device further comprising

a control unit configured to generate a control signal for controlling the self-propelled robot to recommend the recommendation commodity to the customer according to the timing.

[Supplementary Note 5]

The information processing device according to Supplementary Note 3 or 4,

wherein the determination unit determines a recommendation method of the recommended commodity by the self-propelled robot to the customer, and

wherein the control unit generates the control signal for recommending the recommended commodity by the recommendation method.

[Supplementary Note 6]

The information processing device according to any one of Supplementary Notes 3 to 5,

wherein the self-propelled robot identifies whether or not a person detected by a sensor is the customer, and

wherein the self-propelled robot recommends the recommended commodity to the person who is identified as the customer by the self-propelled robot.

[Supplementary Note 7]

The information processing device according to any one of Supplementary Notes 1 to 6,

wherein the determination unit determines the recommended commodity based on at least one of the purchase record information or the individual attribute information.

[Supplementary Note 8]

The information processing device according to any one of Supplementary Notes 1 to 7, further comprising

a prediction unit configured to predict purchase tendency of the customer based on the purchase record information,

wherein the determination unit determines the timing based on the purchase record information and the presence information.

[Supplementary Note 9]

The information processing device according to any one of Supplementary Notes 1 to 8, wherein the determination unit determines a time or a time slot as the timing.

[Supplementary Note 10]

The information processing device according to any one of Supplementary Notes 1 to 8,

wherein the determination unit determines the timing to be a timing based on an occurrence of a predetermined event.

[Supplementary Note 11]

The information processing device according to any one of Supplementary Notes 1 to 8,

wherein the determination unit recognizes that the timing has come if the determination unit detects a predetermined state of the customer.

[Supplementary Note 12]

The information processing device according to any one of Supplementary Notes 1 to 11, further comprising

an updating unit configured to update the purchase record information based on a purchase record of the mobile sales to the customer according to the timing.

[Supplementary Note 13]

The information processing device according to any one of Supplementary Notes 1 to 12,

wherein the acquisition unit extracts the presence information from information indicative of a schedule of the customer.

[Supplementary Note 14]

A control method executed by an information processing device, the control method comprising:

acquiring
at least one of purchase record information indicative of a purchase record or the individual attribute information relating to an attribute of a customer who is a subject of mobile sales of a commodity
and presence information relating to a presence of the customer, the purchase record including a date and time of a purchase by the customer; and

determining, based on at least one of the purchase record information or the individual attribute information and the presence information, a timing of moving sales of a recommended commodity to be recommended to the customer.

[Supplementary Note 15]

A storage medium storing a program executed by a computer, the program causing the computer to function as:

an acquisition unit configured to acquire
at least one of purchase record information indicative of a purchase record or the individual attribute information relating to an attribute of a customer who is a subject of mobile sales of a commodity
and presence information relating to a presence of the customer, the purchase record including a date and time of a purchase by the customer; and

a determination unit configured to determine, based on at least one of the purchase record information or the individual attribute information and the presence information, a timing of moving sales of a recommended commodity to be recommended to the customer.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1, 1A to 1C Information processing device
2, 2B Storage device
3 Sales target space
4 Self-propelled robot
5 Commodity compartment
9 Output device
100, 100A, 100B Commodity sales promotion system

What is claimed is:

1. An information processing device comprising:
at least one memory configured to store instructions; and
at least one processor configured to execute the instructions to
acquire
at least one of purchase record information indicative of a purchase record or the individual attribute information relating to an attribute of a customer who is a subject of mobile sales of a commodity
and presence information relating to a presence of the customer,
the purchase record including a date and time of a purchase by the customer; and
determine, based on at least one of the purchase record information or the individual attribute information and the presence information, a timing of moving sales of a recommended commodity to be recommended to the customer.

2. The information processing device according to claim 1,
wherein the at least one processor is configured to execute the instructions to further acquire environmental information relating to environment in which the customer is present, and
wherein the at least one processor is configured to execute the instructions to determine the timing based on the environmental information, at least one of the purchase result information or the individual attribute information, and the presence information.

3. The information processing device according to claim 1,
wherein the at least one processor is configured to execute the instructions to transmit a control signal for instructing a self-propelled robot having at least the recommended commodity to recommend the recommended commodity to the customer according to the timing.

4. The information processing device according to claim 1,
wherein the information processing device is incorporated in a self-propelled robot which has at least the recommended commodity, and
wherein the at least one processor is configured to execute the instructions to
generate a control signal for controlling the self-propelled robot to recommend the recommendation commodity to the customer according to the timing.

5. The information processing device according to claim 3,
wherein the at least one processor is configured to execute the instructions to determine a recommendation method of the recommended commodity by the self-propelled robot to the customer, and
wherein the at least one processor is configured to execute the instructions to generate the control signal for recommending the recommended commodity by the recommendation method.

6. The information processing device according to claim 3,
wherein the self-propelled robot identifies whether or not a person detected by a sensor is the customer, and
wherein the self-propelled robot recommends the recommended commodity to the person who is identified as the customer by the self-propelled robot.

7. The information processing device according to claim 1,
wherein the at least one processor is configured to execute the instructions to determine the recommended commodity based on at least one of the purchase record information or the individual attribute information.

8. The information processing device according to claim 1,
wherein the at least one processor is configured to execute the instructions a to predict purchase tendency of the customer based on the purchase record information,
wherein the at least one processor is configured to execute the instructions to determine the timing based on the purchase record information and the presence information.

9. The information processing device according to claim 1,
wherein the at least one processor is configured to execute the instructions to determine a time or a time slot as the timing.

10. The information processing device according to claim 1,
wherein the at least one processor is configured to execute the instructions to determine the timing to be a timing based on an occurrence of a predetermined event.

11. The information processing device according to claim 1,
wherein the at least one processor is configured to execute the instructions to recognize that the timing has come if a predetermined state of the customer is detected.

12. The information processing device according to claim 1,
wherein the at least one processor is configured to execute the instructions to update the purchase record information based on a purchase record of the mobile sales to the customer according to the timing.

13. The information processing device according to claim 1,
wherein the at least one processor is configured to execute the instructions to extract the presence information from information indicative of a schedule of the customer.

14. A control method executed by an information processing device, the control method comprising:
acquiring
at least one of purchase record information indicative of a purchase record or the individual attribute information relating to an attribute of a customer who is a subject of mobile sales of a commodity
and presence information relating to a presence of the customer,
the purchase record including a date and time of a purchase by the customer; and
determining, based on at least one of the purchase record information or the individual attribute information and the presence information, a timing of moving sales of a recommended commodity to be recommended to the customer.

15. A non-transitory computer readable storage medium storing a program executed by a computer, the program causing the computer to:
acquire
at least one of purchase record information indicative of a purchase record or the individual attribute information relating to an attribute of a customer who is a subject of mobile sales of a commodity
and presence information relating to a presence of the customer,
the purchase record including a date and time of a purchase by the customer; and
determine, based on at least one of the purchase record information or the individual attribute information and the presence information, a timing of moving sales of a recommended commodity to be recommended to the customer.
